(19) United States
(12) Patent Application Publication
(10) Pub. No.: US 2011/0018161 A1
(43) Pub. Date: Jan. 27, 2011

(54) Method of fabricating keycaps

(76) Inventor: Chung-Hsin Yang, Taoyuan (TW)

Correspondence Address: NORTH AMERICA INTELLECTUAL PROPERTY CORPORATION, P.O. BOX 506, MERRIFIELD, VA, 22116, US

(21) Appl. No.: 12/576,249

(22) Filed: Oct. 9, 2009

(30) Foreign Application Priority Data
Jul. 23, 2009 (TW) 098124857

(51) Int. Cl. B29C 43/00

(52) U.S. Cl. 264/153

(57) ABSTRACT

A method of fabricating a keycap, in which, a metal sheet is provided, and the metal sheet is pressed to form a plurality of keycap-shaped regions, each having a recess portion. The pressed metal sheet is subjected to laser cutting at each keycap-shaped region to form a pattern by cutting out a part of the metal sheet. The recess of each keycap-shaped region is filled with a transparent plastic material, and the metal sheet is punched to form separated keycap-shaped components. These two steps can be switched each other in the order. The separated keycap-shaped components may be each further combined with a pad, respectively.

### BACKGROUND OF THE INVENTION

1. Field of the Invention

The present invention relates to a method of fabricating a keycap, and particularly to a method of fabricating a keycap with a metal exterior, such as a thin-type metal keycap.

2. Description of the Prior Art

Electronic products such as cell phones, smart phones, personal digital assistants (PDAs) and the like usually have keypad keyboards. In present market, keypad keyboards are mainly categorized into metal keypad keyboards and plastic keypad keyboards. Conventionally, the figures such as numerals, symbols and English letters on the keypad keyboards are formed through printing or etching a metal sheet to form the figure patterns, pressing the metal sheet into a metallic keycap shape, filling the metallic keycap shape of the metal sheet with a plastic material and punching the metal sheet to form a separate keycap component. However, since the figures are formed on the metal sheet first, when the metal sheet is pressed to form a desired shape, the figures are prone to deformation due to stretching in the pressing formation. Furthermore, if the figure patterns are formed by etching, the line edge of the patterns will not be smooth due to etching effect. These are disadvantageous to the aesthetic appearance of the keycaps.

Regarding metallic keycap, there are other formation methods. For example, Japan patent application publication No. 2005346926 discloses a marking method to metal-plated key providing a method of directly marking letters or signs on a plated face by irradiating laser light on a metal-plated face applied on a plastic key top. As laser light for marking, either laser light with a wavelength of 532 nm obtained by taking out second harmonic of Nd:YAG laser or laser light with a wavelength of 355 nm obtained by taking out third harmonic of the same laser is used. As shown in FIG. 1, a metal plated layer 5 wraps plastic keycap 1. The keycap 1 and the pad 2 are combined together through an adhesive layer 4. The pad 2 is connected to a metal dome 3 through a plunger. A laser 6 irradiates the metal plated layer 5 wrapping the plastic keycap 1 to form figure pattern. Accordingly, in this method, the metal plated layer 5 is first formed on the keycap 1, and then a laser cutting is performed. A part of the metal plated layer 5 is cut away in the laser cutting, such that the top surface of the entire key has recesses or indentions and not smooth, and moreover the underlying plastic material is prone to being damaged during the laser cutting process for hollowing out a part of the metal layer. Both situations affect the aesthetic appearance of the keycaps.

Since the keypad keyboards of the electronic products have to be relatively thin and small and with an aesthetic appearance, so as to accord with the demand of the market. Therefore, there is still a need for a novel aesthetic keypad without deformed figure patterns.

### SUMMARY OF THE INVENTION

An objective of the present invention is to provide a method of fabricating a keycap to fabricate a keycap with a metal surface.

The method of fabricating a keycap according to one embodiment of the present invention comprises steps as follows. First, a metal sheet is provided. Next, the metal sheet is pressed to form a plurality of keycap-shaped regions, and each keycap-shaped region comprises a recess portion. Thereafter, a laser cutting process is performed on the pressed metal sheet to form a pattern at each keycap-shaped region by cutting out a part of the metal sheet. The recess portion of each keycap-shaped region is filled with a transparent plastic material and the metal sheet is punched to separate each of the keycap-shaped regions. These two steps may be switched in the order.

The separated keycap-shaped region may be further combined with the pad.

In another aspect, the method of fabricating a keycap according to another embodiment of the present invention comprises steps as follows. First, a metal sheet is provided. The metal sheet is pressed to form a plurality of keycap-shaped regions, and each keycap-shaped region comprises a recess portion. A laser cutting process is performed on the pressed metal sheet to form a pattern at each keycap-shaped region by cutting out a part of the metal sheet. The recess portion of each keycap-shaped region is filled with a transparent plastic material. The metal sheet is punched to separate each of the keycap-shaped regions. A polycarbonate (PC) film is punched to form a plurality of small pieces. The small pieces are co-molded with a silicone rubber material to form a laminate. The laminate is punched to form a plurality of pads, and thereby each of the pads comprises one of the small pieces and the silicone rubber material. One of the pads and one of the separated keycap-shaped regions is assembled correspondingly.

In the method of fabricating a keycap according to the present invention, the metal sheet is formed into a keycap shape followed by a laser cutting process to be endowed with a desired pattern. Accordingly, the cutting edge of the pattern can be smooth and the pattern can be subtle and elegant. Furthermore, when the recess portion of the keycap-shaped region is filled with a transparent plastic material, the hollowed pattern is also filled up with the transparent plastic material. Accordingly, the appearance of the keycap can be smooth, and the metal sheet, even near the hollowed location, can be reinforced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a schematic cross-sectional view illustrating a conventional method of fabricating a keycap;

FIG. 2 shows a flow chart according to an embodiment of the method of fabricating a keycap of the present invention;

FIG. 3 shows a schematic diagram illustrating a pressed metal sheet according to an embodiment of the method of the present invention;

FIGS. 4 to 6 show schematic cross-sectional views illustrating some keycap structures made in some embodiments of the method of the present invention; and

FIG. 7 shows a schematic plane view of a keycap-shaped region according to an embodiment of the method of the invention and its schematic cross-sectional perspective view taken along line AA′.

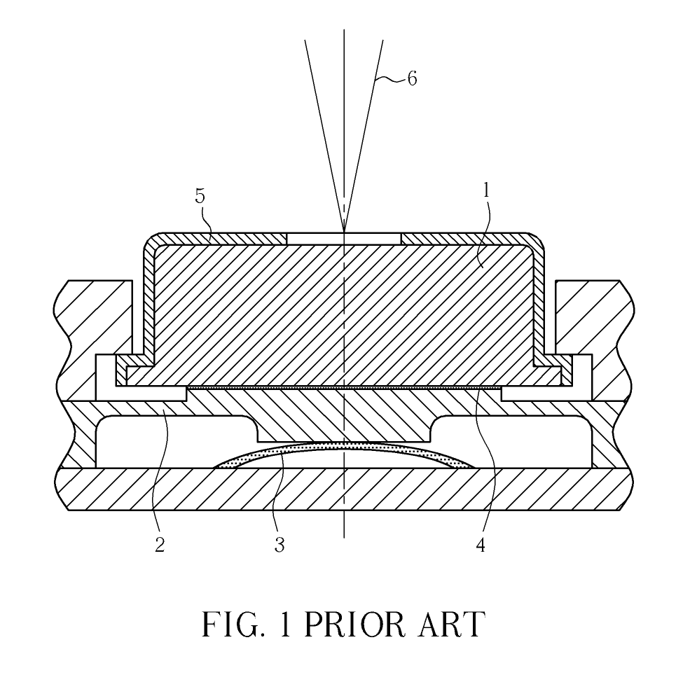

### DETAILED DESCRIPTION

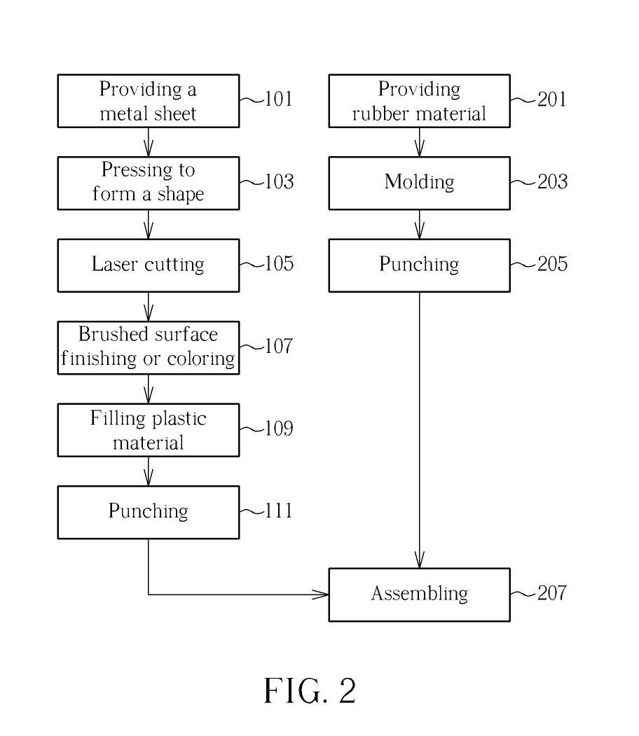

FIG. 2 shows a flow chart according to an embodiment of the method of fabricating a keycap of the present invention. First, in a step 101, a metal sheet is provided. It is preferred that the metal sheet has ductility or malleability properties suitable for pressing formation, a certain stiffness suitable for being filled with plastic material, and properties suitable for laser cutting. It may be, for example, an aluminum alloy sheet. The thickness may be 0.2 mm or greater or other as desired without particular limitation. If the metal sheet is too thick, it may be not easy to be pressed to form a shape. If the metal sheet is too thin, it tends to be fractured in the process. The thickness of 0.3 mm for the metal sheet may be used in a thin-type keypad. Thereafter, a step 103 is performed to press the metal sheet to form a plurality of keycap-shaped regions. The metal sheet may be pressed by a press machine in a mold such as a male mold or a female mold to form a desired shape having one or more recess portions. For a metal sheet with a thickness of 0.2 mm, the depth of the recess portion may be for example 0.8 mm to 1 mm, but is not limited thereto and may be other as desired.

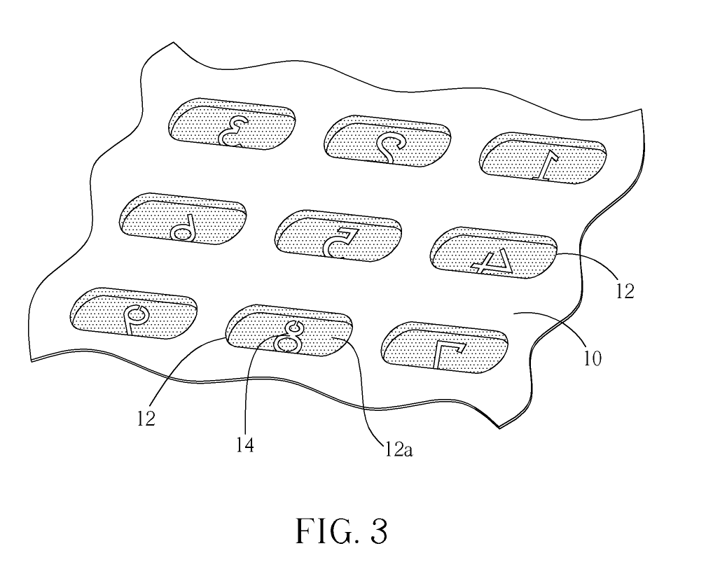

Thereafter, a step 105 is performed to laser cutting the metal sheet at the keycap-shaped regions to remove cut portions and form patterns. The patterns are as desired, for example, numerals, symbols, English letters, figures, and the like. The pattern may be a hollowed pattern passing through the metal sheet. Since a laser beam may be a fine light beam with a small diameter such as 0.06 mm, a subtle hollowed pattern can be formed. For example, the hollowed pattern may have a small line width of, for example, 0.15 mm, or even less (for example down to 0.1 mm), and it is able to be located very close to a bend or curve place of the pressed metal sheet. The pattern is formed at the keycap-shaped region, but not limited to the bottom or the sidewall of the recess portion or the connection place of the bottom and the sidewall. In an embodiment as illustrated by FIG. 3, the metal sheet 10 is pressed to have a plurality of keycap-shaped regions 12. In this drawing, the recessed side of the keycap-shaped regions is viewed and the bottom 12a (when the bulged side is view, 12a is referred to key top) of the keycap-shaped region 12 is laser cut to have a hollowed pattern 14.

In a certain embodiment, for example, a UV laser with a wavelength of 355 nm may be used to cut an aluminum alloy sheet. Nevertheless, the present invention is not limited to the certain examples, and many conditions may be adopted as long as the metal sheet can be cut by laser.

After the pattern is formed using laser cutting, a step 107 of brushed surface finish or coloring process is performed on the metal sheet to enhance the appearance. The coloring process may be for example an electroplating, anodic electroplating, coating, or printing process. The step 107 may be carried out or not, and it may be carried out after other steps; yet it is preferred to carried out after the laser cutting to prevent the brushed surface pattern or colored layer from being damaged during the laser cutting or the punching process, or before the step of filling plastic material to avoid harming the plastic material or affecting the combination of the plastic material and the metal sheet.

Thereafter, a step 109 is performed to fill a transparent plastic material in the recess portion of the keycap-shaped region. Thereafter, a step 111 is carried out to punch the metal sheet to separate each keycap-shaped region. Because the transparent plastic material has been filled in the recess portion of the keycap-shaped region, the metal sheet is punched with the transparent plastic material together, to form a metal component. Alternatively, in another embodiment of the present invention, the step 111 may be carried out before the step 109. That is, the metal sheet is punched to separate each keycap-shaped region, and then the recess portion of the separated keycap-shaped region is filled with a transparent plastic material to form a metal component. In the former step order, since the filling process is performed on a whole metal sheet, the process is simpler and faster, and consequently more efficient. In the later step order, since the filling process is performed after the discrete keycap-shaped region is obtained, the process is slower, but more precise.

The transparent plastic material may include polycarbonate, silicone rubber, or UV light cured resin, and the like, but is not limited thereto. The step of filling the recess portion of the keycap-shaped region with the transparent plastic material may be performed through for example co-molding the keycap-shaped region of the metal sheet and the transparent plastic material. Proper compression strength may be used to avoid damage to the hollowed pattern or deformation of the keycap-shaped region of the metal sheet. A heating or light curing process may be further carried out, depending on the properties of the transparent plastic material.

Alternatively, a plurality of pads may be further provided. The pad may include for example, rubber or silicone rubber material. A keycap structure is formed through assembling each metal component and the pad.

The pad may be formed through steps 201, 203 and 205 in the flow chart as shown in FIG. 2. First, in the step 201, a rubber or silicone rubber material is provided. In the step 203, the rubber or silicone rubber material is molded to form a desired shape. In the step 205, the rubber or silicone rubber material is punched to form a pad corresponding to a desired key. Finally, in a step 207, the metal component and the rubber or silicone rubber pad are assembled by adhesion through for example an adhesive layer or adhesive tape, to form a keycap.

In another embodiment of the present invention, the pad may be achieved as follows. First, a PC film is punched to form a plurality of small pieces. Thereafter, the small pieces and a silicone rubber material are co-molded to form a laminate. Then, the laminate is punched to form a plurality of pads. Each of the pads comprises one of the small piece and the silicone rubber material. Thereafter, the pads and the metal component are assembled correspondingly, for example, through an adhesive layer.

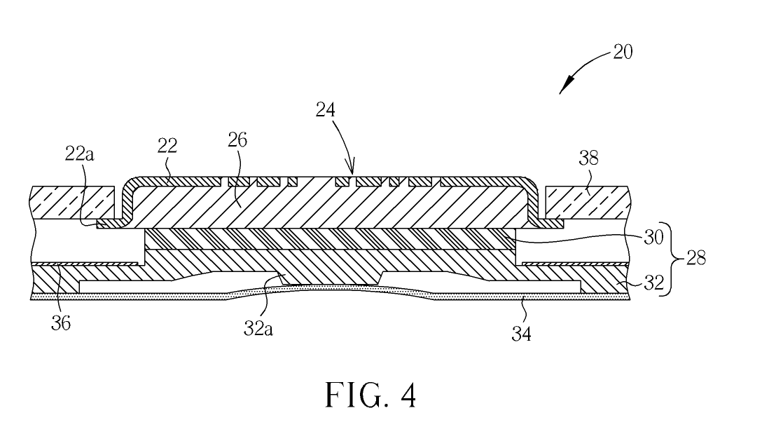

FIG. 4 schematically shows an embodiment of a keycap structure made from the method of the present invention. The keycap structure 20 includes a keycap-shaped region 22 formed of a metal sheet. The key top of the keycap-shaped region 22 has a pattern, which is a hollowed pattern 24, formed through laser cutting. A plastic material 26 is disposed within the recess portion of the keycap-shaped region 22. The pad 28 is formed by co-molding a PC film 30 with a silicone rubber 32 together. The bottom surface of the silicone rubber 32 may be formed into a plunger shape 32a, for delivering a pressure to a metal dome 34 upon key press. A light shielding layer 36 may be further disposed around the silicone rubber 32 of the pad 28 to shield light around the keycap for prevent from light leakage.

The keycap-shaped region 22 preferably has a skirt 22a. The skirt 22a can insure the assembly of the keycap-shaped region and the electronic product casing 38 for avoiding unwanted detachment and light leakage.

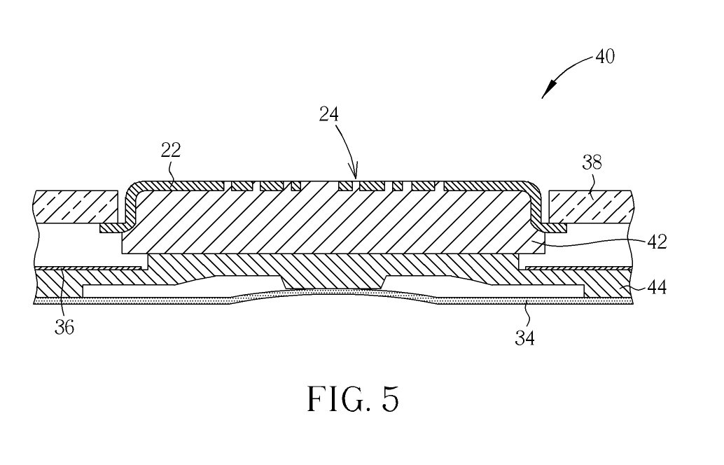

The transparent plastic material 26 may fully fill the recess portion of the keycap-shaped region 22 as shown in FIG. 4, or be over the recess portion as shown in FIG. 5, or partly fill the recess portion. In the keycap structure 40 in FIG. 5, the height of the plastic material 42 in the recess portion of the keycap-shaped region 22 is greater than the depth of the recess portion, and the pad 44 comprises silicone rubber. Overall, the height of the keycap may be as desired.

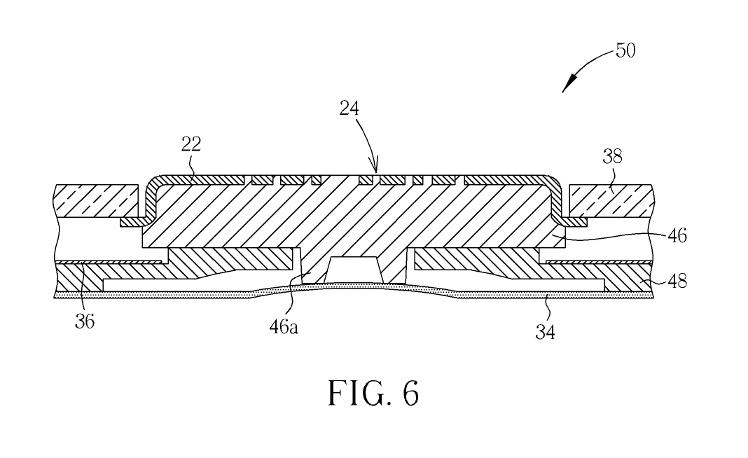

When the recess portion of the keycap-shaped region is filled with the transparent plastic material by a co-molding process, a surface of the transparent plastic material may be further molded to form into an M shape for serving as a plunger needed in key press, as shown in FIG. 6. FIG. 6 illustrates a keycap structure 50. The plastic material 46 disposed in the recess portion of the keycap-shaped region 22 has a height more than the depth of the recess portion and is formed into an M-shaped plunger 46a on the bottom surface. The pad 48 has an opening corresponding to the shape of the plunger 46a for allowing the plunger 46a to pass through.

One feature of the present invention is that the metal sheet is laser-cut to form a hollowed pattern and when the keycap-shaped region is filled with the transparent plastic material, the hollowed pattern can be filled by the transparent plastic material to have a smooth appearance without depression or indentions. The embodiments illustrated by FIGS. 4, 5 and 6 show such feature.

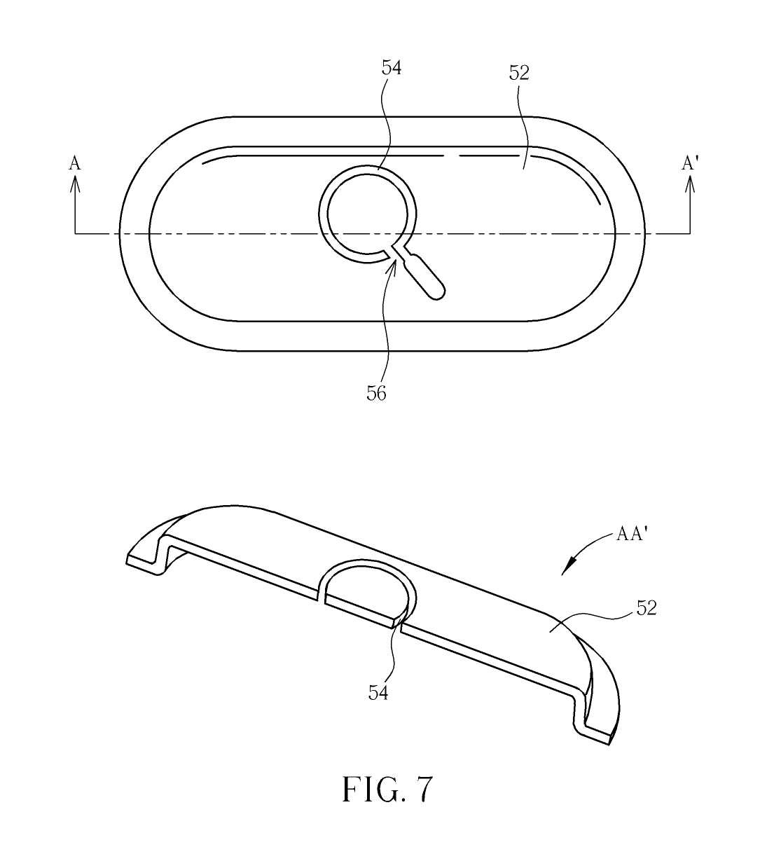

FIG. 7 shows a schematic plan view of a keycap-shaped region and its schematic cross-sectional perspective view taken along line AA′. The keycap-shaped region 52 is obtained according to the present invention through forming the metal sheet into keycap-shapes, laser cutting to form desired pattern 54 on the keycap, and punching. There are advantages for such process as follows, for example. The pattern 54 will not undergo stretching and thus can maintain original pattern. Since the pattern is formed by laser cutting, the edge of the pattern is smooth. Since the pattern is formed by laser cutting, the line width and the connection part 56 depend on the diameter of the laser and can be very narrow. When the connection part 56 is very narrow, it is not easily sighted, and thus the pattern is looked more beautiful. Furthermore, since the transparent plastic material fully fills the hollowed pattern, the keycap-shaped region is reinforced and has a smooth appearance.

Those skilled in the art will readily observe that numerous modifications and alterations of the device and method may be made while retaining the teachings of the invention.

What is claimed is:

1. A method of fabricating a keycap, comprising:
providing a metal sheet;
pressing the metal sheet to form a plurality of keycap-shaped regions, each of the keycap-shaped regions comprising a recess portion;
performing a laser cutting process on the pressed metal sheet to form a pattern at each of the keycap-shaped regions by cutting out a part of the metal sheet;
filling the recess portion of each of the keycap-shaped regions with a transparent plastic material; and
punching the metal sheet to separate each of the keycap-shaped regions.

2. The method of claim 1, wherein the step of punching the metal sheet to separate each of the keycap-shaped regions is performed after the step of filling the recess portion of each of the keycap-shaped regions with the transparent plastic material is performed, thereby to form a plurality of metal components.

3. The method of claim 2, further comprising providing a plurality of pads and assembling each of the pads and each of the metal components correspondingly.

4. The method of claim 1, wherein the step of filling the recess portion of each of the keycap-shaped regions with the transparent plastic material is performed after the step of punching the metal sheet to separate each of the keycap-shaped regions is performed, thereby to form a plurality of metal components.

5. The method of claim 4, further comprising providing a plurality of pads and assembling each of the pads and each of the metal components correspondingly.

6. The method of claim 1, wherein each of the separated keycap-shaped regions comprises a skirt.

7. The method of claim 1, wherein the transparent plastic material is fully filled within the recess portion of each of the keycap-shaped regions or is fully filled within and over the recess portion.

8. The method of claim 1, wherein the transparent plastic material is partially filled within the recess portion of each of the keycap-shaped regions.

9. The method of claim 1, further comprising performing a brushed surface finish process or an anodic electroplating process for coloring the metal sheet.

10. The method of claim 1, wherein the transparent plastic material comprises polycarbonate, silicone rubber, or UV light cured resin.

11. The method of claim 1, wherein the step of filling the recess portion of each of the keycap-shaped regions with the transparent plastic material comprises performing a co-molding process.

12. The method of claim 11, wherein the transparent plastic material is molded to have one surface in an M-shape to be as a plunger.

13. The method of claim 1, wherein the pattern formed by using the laser cutting process comprises a hollowed-out pattern and the hollowed-out pattern is filled with the transparent plastic material to become smooth.

14. A method of fabricating a keycap, comprising:
providing a metal sheet;
pressing the metal sheet to form a plurality of keycap-shaped regions, each keycap-shaped region comprising a recess portion;
performing a laser cutting process on the pressed metal sheet to form a pattern at each of the keycap-shaped regions by cutting out a part of the metal sheet;
filling the recess portion of each of the keycap-shaped regions with a transparent plastic material;
punching the metal sheet to separate each of the keycap-shaped regions;
punching a polycarbonate film to form a plurality of small pieces;
co-molding the small pieces with a silicone rubber material to form a laminate;
punching the laminate to form a plurality of pads, thereby each of the pads comprising one of the small pieces and the silicone rubber material; and
assembling each of the pads and each of the separated keycap-shaped regions correspondingly.

15. The method of claim 14, wherein each of the pads and each of the separated keycap-shaped regions are combined together through an adhesive layer.

16. The method of claim 14, further comprising performing a brushed surface finish process or an anodic electroplating process for coloring the metal sheet.

17. The method of claim 14, wherein,
the step of filling the recess portion of each of the keycap-shaped regions with the transparent plastic material is performed after the step of punching the metal sheet to separate each of the keycap-shaped regions is performed, thereby to form a plurality of metal components; and
the step of assembling one of the pads and one of the separated keycap-shaped regions correspondingly comprises combining each of the pads and each of the metal components together through an adhesive layer.

18. The method of claim 14, wherein,
the step of punching the metal sheet to separate each of the keycap-shaped regions is performed after the step of filling the recess portion of each of the keycap-shaped regions with the transparent plastic material is performed, thereby to form a plurality of metal components; and
the step of assembling one of the pads and one of the separated keycap-shaped regions correspondingly comprises combining each of the pads and each of the metal components together through an adhesive layer.

19. The method of claim 14, wherein the step of filling the recess portion of each of the keycap-shaped regions with the transparent plastic material comprises performing a co-molding process.

20. The method of claim 14, wherein the pattern formed by using the laser cutting process comprises a hollowed-out pattern and the hollowed-out pattern is filled with the transparent plastic material to become smooth.
